(19) United States
(12) Patent Application Publication
(10) Pub. No.: US 2017/0335239 A1
(43) Pub. Date: Nov. 23, 2017

(54) LIQUID LAUNDRY DETERGENT CONTAINING AMINE ADDITIVES

(71) Applicant: Rohm and Haas Company, Philadelphia, PA (US)

(72) Inventor: Gaelle Della Noce, Tourettes Sur Loup (FR)

(21) Appl. No.: 15/520,890

(22) PCT Filed: Oct. 21, 2015
(86) PCT No.: PCT/US15/56607

§ 371 Date: Apr. 21, 2017

(30) Foreign Application Priority Data
Oct. 22, 2014 (EP) 14290319.4

(51) Int. Cl. C11D 1/83; C11D 1/22; C11D 1/72; C11D 3/30

(52) U.S. Cl. CPC C11D 1/83; C11D 3/30; C11D 1/22; C11D 1/72

(57) ABSTRACT

A liquid laundry detergent composition comprising: (a) 10 to 30 wt % of a linear alkyl benzene sulfonate; (b) 4 to 18 wt % linear alcohol ethoxylate, and (c) 2 to 10 wt % of an amine having formula (I)

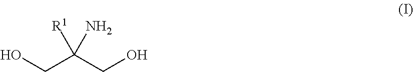

wherein R¹ is C₁-C₄ alkyl or C₁-C₄ hydroxyalkyl; or formula (II)

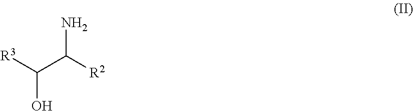

wherein R² is C₁-C₄ alkyl and R³ is C₂-C₈ alkyl; or a combination thereof; and (d) water.

### BACKGROUND

This invention relates generally to a liquid laundry detergent composition containing amines

Typically, liquid laundry detergent compositions are adjusted to an alkaline pH using sodium hydroxide. In some cases, other bases have been used for this purpose. For example, U.S. Pat. No. 5,035,838 discloses use of triethanolamine for neutralization of a detergent composition. However, this reference does not disclose the compositions of the present invention, which offer improved performance.

### STATEMENT OF INVENTION

The present invention is directed to a liquid laundry detergent composition comprising: (a) 10 to 30 wt % of a linear alkyl benzene sulfonate; (b) 4 to 18 wt % linear alcohol ethoxylate, (c) 2 to 10 wt % of an amine having formula (I)

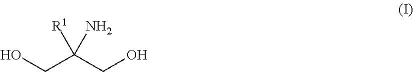

wherein R¹ is C₁-C₄ alkyl or C₁-C₄ hydroxyalkyl; or formula (II)

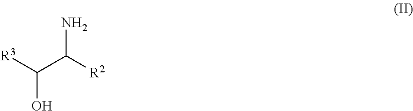

wherein R² is C₁-C₄ alkyl and R³ is C₂-C₈ alkyl; or a combination thereof; and (d) water.

### DETAILED DESCRIPTION

All percentages are weight percentages (wt %), and all temperatures are in ° C., unless otherwise indicated. All operations are performed at room temperature (20-25° C.) unless otherwise specified. As used herein the term “citrate” refers to alkali metal citrates. Preferably, citrates are sodium, potassium or lithium salts; preferably sodium or potassium; preferably sodium. Weight percentages of citrates are based on the actual weights of the salts, including metal ions. As used herein the term “fatty acid” refers to aliphatic carboxylic acids having from twelve to twenty-two carbon atoms, preferably fourteen to eighteen. The term “phosphorus-free” refers to compositions containing less than 0.5 wt % phosphorus (as elemental phosphorus), preferably less than 0.2 wt %, preferably less than 0.1 wt %, preferably no detectable phosphorus. Weight percentages in the detergent composition are percentages of active ingredients, i.e., excluding any water that may be present in the commercially available surfactants or other ingredients.

Preferably the amine having formula (I) is present in the liquid laundry detergent composition in an amount of at least 3 wt %; preferably at least 3.5 wt %, preferably at least 4 wt %, preferably at least 4.5 wt %; preferably no more than 8 wt %, preferably no more than 7 wt %, preferably no more than 6.5 wt %.

Preferably, R¹ is C₁-C₃ alkyl or C₁-C₃ hydroxyalkyl, preferably C₁-C₂ alkyl or C₁-C₂ hydroxyalkyl; preferably methyl, ethyl or hydroxymethyl.

Preferably the amine having formula (II) is present in the liquid laundry detergent composition in an amount of at least 3.5 wt %; preferably at least 4.5 wt %, preferably at least 5 wt %, preferably at least 5.5 wt %, preferably at least 6 wt %; preferably no more than 9.5 wt %, preferably no more than 9 wt %, preferably no more than 8.5 wt %.

Preferably, R² is C₁-C₃ alkyl, preferably methyl or ethyl, preferably ethyl. Preferably, R³ is C₂-C₆ alkyl, preferably C₃-C₆ alkyl, preferably C₃-C₅ alkyl, preferably C₄ alkyl, preferably n-butyl.

Preferably, the total amount of amine in the detergent composition is from 2.5 to 9 wt %, preferably from 2.5 to 8.5 wt %, preferably from 3 to 8 wt %.

Preferably, the detergent composition comprises at least 5 wt % linear alcohol ethoxylates, preferably at least 6 wt %, preferably at least 7 wt %; preferably no more than 17 wt %, preferably no more than 16 wt %, preferably no more than 15 wt %. Preferably, a linear alcohol ethoxylate has a linear C₆-C₁₈ alkyl group, preferably C₈-C₁₆, preferably C₁₂-C₁₅. The alkyl groups may be mixtures of different alkyl groups in the indicated range. Preferably, a linear alcohol ethoxylate comprises from five to nine polymerized units of ethylene oxide, preferably six to eight, preferably seven.

Preferably, the detergent composition comprises at least 12 wt % linear alkylbenzene sulfonates, preferably at least 13 wt %, preferably at least 14 wt %; preferably no more than 27 wt %, preferably no more than 25 wt %, preferably no more than 23 wt %. Preferably, alkylbenzene sulfonates have a C₁₀-C₁₄ alkyl group.

Preferably, the detergent composition comprises from 1 to 15 wt % fatty acids or their metal salts; preferably at least 3 wt %, preferably at least 4 wt %, preferably at least 5 wt %; preferably no more than 13 wt %, preferably no more than 12 wt %, preferably no more than 11 wt %.

Preferably, detergent composition comprises from 0.5 to 10 wt % citrate salts; preferably at least 1 wt %, preferably at least 1.5 wt %; preferably no more than 8 wt %, preferably no more than 6 wt %, preferably no more than 5 wt %.

Preferably, the detergent composition comprises from 1 to 15 wt % alcohol and/or glycol solvents, e.g., propylene glycol and ethanol. Preferably the solvent is propylene glycol or ethanol. Preferably, the detergent composition comprises at least 2 wt % solvent, preferably at least 3 wt %, preferably at least 4 wt %; preferably no more than 12 wt %, preferably no more than 10 wt %, preferably no more than 9 wt %.

Preferably, the detergent composition comprises from 30 to 70 wt % water; preferably at least 35 wt %, preferably at least 38 wt %, preferably at least 41 wt %, preferably at least 43 wt %; preferably no more than 65 wt %, preferably no more than 62 wt %, preferably no more than 59 wt %, preferably no more than 57 wt %.

Preferably, the detergent composition comprises from 0.5 to 10 wt % hydrotropes or their salts, preferably 0.5 to 6 wt %, preferably 1 to 5 wt %. A preferred example of a hydrotrope is an aromatic sulfonic acid, preferably touenesulfonic acid.

Other components of the detergent composition may include, e.g., surfactants, oxygen and/or chlorine bleaches, bleach activators, enzymes, foam suppressants, colors, fragrances, antibacterial agents and fillers. Fragrances, dyes, foam suppressants, enzymes and antibacterial agents usually total no more than 5 wt % of the composition.

Preferably, the detergent composition has a pH from 7.5 to 10, preferably at least 8, preferably no more than 9.5, preferably no more than 9.

The detergent composition can be used under typical operating conditions for any typical washing machine. Typical water temperatures during the washing process preferably are from 20° C. to 85° C., preferably from 25° C. to 70° C. Typical concentrations for the composition as a percentage of total liquid in the dishwasher preferably are from 0.1 to 1 wt %, preferably from 0.2 to 0.7 wt %. With selection of an appropriate product form and addition time, the composition may be present in the prewash, main wash, penultimate rinse, final rinse, or any combination of these cycles.

Preferably, the detergent composition is substantially free of enzymes, i.e., it contains less than 0.5 wt % enzymes, preferably less than 0.2 wt %, preferably less than 0.1 wt %, preferably it contains no detectable enzymes. Preferably, the detergent composition contains less than 2 wt % of amine oxide surfactants, preferably less than 1 wt %, preferably less than 0.5 wt %, preferably less than 0.2 wt %. Preferably, the detergent composition is substantially free of amines other than the amines of formulas (I) and (II), i.e., these other amines are present in a total amount less than 0.7 wt %, preferably less than 0.5 wt %, preferably less than 0.3 wt %, preferably less than 0.2 wt %.

### EXAMPLES

The benefit of neutralization with amino alcohols versus conventional neutralizer (NaOH) on various stains in the DOW High Duty Liquid formulation (wash cycle at 30° C.) was investigated by looking at the primary cleaning i.e the stain removal. The color of each stain was measured before wash and after wash.

### Protocol:

The various amino alcohols have been added in the following formulation:

| | % ACTIVE |
|---|---|
| Dow High Duty Liquid Laundry composition | (in finished |
| (in order of addition) | product) |
| Deionized Water | 50 |
| Linear Alkyl Benzene Sulfonate (NANSA | 19 |
| SS80 from Huntsman) | |
| Alcohol Ethoxylate (NEODOL 25-7 from | 11 |
| Kleom) | |
| Trisodium Citrate 2H₂O (from Merck) | 2 |
| Propylene Glycol (from VWR International) | 5 |
| Fatty acid soap (PALMERA B1220 from | 8.5 |
| KLK) | |
| Ethanol absolute (from Merck) | 2 |
| hydrotrope (ELTESOL SX30 from | 2.5 |
| Huntsman) | |
| Neutralizer | qsp to pH 8.5 |
| Deionized Water | to 100% |

### % Neutralizer Used (in Order to Obtain a pH of 8.5):

| | | |
|---|---|---|
| AEPD Vox 1000 | 5.6 | (2-amino-2-ethyl-1,3-propanediol) |
| AMP 90 (comp.) | 3.7 | (2-amino-2-methyl-1-propanol) |
| Corrguard EXT | 7.4 | (3-amino-4-octanol) |
| Tris Amino Ultra | 6.3 | (2-amino-2-hydroxymethyl-1.3-propanediol) |
| NaOH (comp.) | 4.9 | |

The stain monitors used for the test were as follow:

Stain Monitors: from Center for Test Materials—Ref MON DOW 7

| Code stains | Nature of stains |
|---|---|
| H078 | Lipstick #1 |
| H156 | Dust sebum |
| H038 | Shoepolish brown |
| H150 | Soja oil/violet dye |
| H013 | Dirty motor oil |
| H032 | Rust stain |
| H084 | nivea visage face cream |
| H135 | Mechanical Grease |
| H082 | Sebum bey with carbon black |
| H066 | tapenada, black olives |
| H018 | Ground soil |
| H134 | Hamburger grease |
| H126 | Pura vegetable oil with violet dye |
| H056 | Sauce Mediterranea, olive sauce |
| H162 | Chicken barbecue fat |
| H145 | Clay tenniscourt |

Each machine was loaded with:

1 stain monitor+1 SBL (soil ballast load of 8 g)
60 g detergent
3.3 kg ballast load
Tap water: TH around 18° F.

Six different cycles were run at 30° C., (with a new stain monitor for each cycle) have been run (=6 replicate)

### Measurements

The soil release effect has been measured via Delta E (ΔE) of each stain.

Delta E is defined as the color difference between the unwashed stain and the washed stain, within the L*a*b* color space.

Each stain was measured, before and after washing, with the Epson Perfection 4490 Photo scanner, using the Epson scan software with the following settings:
Professional mode.
Document type: reflective
Documents source: Document table
Auto exposure type: photo
Image type: 48-bit color
scanner quality: best
Resolution: 400 dpi
No color correction
UV cut 400 nm

Then, the color of each stain have been analyzed with the software Image J version 1.4.3.67 (free software available from the Internet) using a macro which provided color information within the L*a*b* color space.

### Results (Means of 6 Different Cycles at 30° C.)

Delta E is defined as the color difference between the unwashed stain and the washed stain, within the L*a*b* color space.

ΔE={square root over ({(L*_{unwashed}−)}L*_{washed})²+(a*_{unwashed}−a*_{washed})²+(b*_{unwashed}−b*_{washed})²}

The results are tabulated below.

Delta E

| | | 5.6% | | 6.3% | |
|---|---|---|---|---|---|
| HDL | 7.4% | AEPD | | Tris | 4.9% |
| neutralised | Corrguard | Vox | 3.7% | Amino | NaOH |
| with | EXT | 1000 | AMP 90 | Ultra | 32% |
| H013 | 35.16 | 22.01 | 21.23 | 21.78 | 21.43 |
| H078 | 32.19 | 30.48 | 33.45 | 58.51 | 42.00 |
| H084 | 24.67 | 30.82 | 28.69 | 37.01 | 30.36 |

Standard deviation

| | | 5.6% | | 6.3% | |
|---|---|---|---|---|---|
| HDL | 7.4% | AEPD | | Tris | 4.9% |
| neutralised | Corrguard | Vox | 3.7% | Amino | NaOH |
| with | EXT | 1000 | AMP 90 | Ultra | 32% |
| H013 | 1.3 | 2.0 | 2.5 | 1.2 | 1.2 |
| H078 | 3.0 | 2.6 | 2.8 | 3.4 | 9.0 |
| H084 | 2.2 | 6.7 | 4.0 | 9.2 | 2.7 |

1. A liquid laundry detergent composition comprising: (a) 10 to 30 wt % of a linear alkyl benzene sulfonate; (b) 4 to 18 wt % linear alcohol ethoxylate, and (c) 2 to 10 wt % of an amine having formula (I) 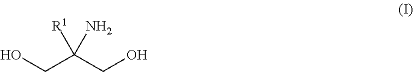
wherein R¹ is C₁-C₄ alkyl or C₁-C₄ hydroxyalkyl; or formula (II) 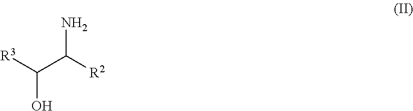
wherein R² is C₁-C₄ alkyl and R³ is C₂-C₈ alkyl; or a combination thereof; and (d) water.

2. The composition of claim 1 in which R¹ is C₁-C₃ alkyl or C₁-C₃ hydroxyalkyl.

3. The composition of claim 2 in which R² is C₁-C₃ alkyl and R³ is C₂-C₆ alkyl.

4. The composition of claim 3 comprising from 30 to 70 wt % of water.

5. The composition of claim 4 comprising from 1 to 15 wt % fatty acids or their metal salts.

6. The composition of claim 5 in which R¹ is methyl, ethyl or hydroxymethyl.

7. The composition of claim 6 in which R² is methyl or ethyl and R³ is C₃-C₅ alkyl.

8. The composition of claim 1 in which said amine has formula (I).

9. The composition of claim 1 in which said amine has formula (II).
